(19) United States
(12) Patent Application Publication
(10) Pub. No.: US 2016/0301575 A1
(43) Pub. Date: Oct. 13, 2016

(54) SET UP AND VERIFICATION OF CABLING CONNECTIONS IN A NETWORK

(71) Applicant: Quanta Computer Inc., Taoyuan City (TW)

(72) Inventors: Maw-Zan JAU, Taoyuan City (TW); Ching-Chih SHIH, Taoyuan City (TW); Tsu-Tai KUNG, Taoyuan City (TW)

(21) Appl. No.: 14/728,332

(22) Filed: Jun. 2, 2015

Related U.S. Application Data
(60) Provisional application No. 62/144,003, filed on Apr. 7, 2015.

(51) Int. Cl. H04L 12/24; H04L 12/26

(52) U.S. Cl. CPC H04L 41/12; H04L 43/50; H04L 41/0866; H04L 41/0813

(57) ABSTRACT

A computing device can be used to set up cabling connections in a network. The computing device can send a first message to a test device through a switch of a server rack. The computing device can receive a response from the test device, and identify a port of the switch currently connected to the test device based on the response. The computing device can use configuration data mapping ports of the switch to servers in the server rack to identify a particular server corresponding to the identified switch port. The computing device can send a second message to the particular server to cause a light of the particular server to be turned on.

### RELATED APPLICATIONS

This application claims priority to U.S. provisional application 62/144,003 filed Apr. 7, 2015, and entitled “SET UP AND VERIFICATION OF CABLING CONNECTIONS IN A NETWORK”, the disclosure of which is hereby incorporated herein by reference in its entirety for all purposes.

### TECHNICAL FIELD

The disclosure generally relates to setting up and verifying cabling configurations on a network.

### BACKGROUND

Conventionally, a network switch operates to direct network information to and from a plurality of servers located at a plurality of server nodes in a network. Servers are typically coupled to ports of a network switch using network cabling (e.g., Ethernet cables). Errors in connecting the servers to the switch ports can lead to incorrect information being exchanged on the network. Because thousands of servers and switches are connected to each other using network cabling in a typical data center, mistakes can arise in the network cabling connections.

### SUMMARY

In some implementations, a computing device can be used to set up cabling connections in a network. For example, the computing device can send a first message to a test device through a switch of a server rack. The computing device can receive a response from the test device, and identify a port of the switch currently connected to the test device based on the response. The computing device can use configuration data mapping ports of the switch to servers in the server rack to identify a particular server corresponding to the identified switch port. The computing device can send a second message to the particular server to cause a light of the particular server to be turned on. The light can indicate the particular server to connect to the identified switch port. The steps can be repeated to set up all the cabling connections in the network.

In some implementations, a computing device can be used to verify cabling connections in a network. For example, the computing device can obtain configuration data comprising a desired mapping of switch ports to servers in a rack. The computing device can receive a current mapping identifying current couplings of each of the switch ports to the servers. The computing device can compare the current mapping to the desired mapping, and provide an error indication to a user when the current mapping does not match the desired mapping. The cabling connections can be corrected according to the desired mapping.

Particular implementations provide at least the following advantages: a system administrator can be guided through the process of connecting switch ports to servers in a rack; and the current switch port to server configuration can be quickly verified to ensure accurate cabling of the switch to servers.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates a diagram of an example system for setting up and verifying cabling connections in a network.

FIG. 2 illustrates an example graphical user interface (GUI) generated by a computing device.

FIG. 3 is a flow diagram of an example process for setting up cabling connections in a network.

FIG. 4 is a flow diagram of an example process for verifying cabling connections in a network.

FIG. 5 is a block diagram of an example system architecture implementing the features and processes of FIGS. 1-4.

Like reference symbols in the various drawings indicate like elements.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and members have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening members, and is not necessarily limited to physical connections. The connection can be such that the objects are permanently connected or releasably connected. The term “substantially” is defined to be essentially conforming to the particular dimension, shape or other word that substantially modifies, such that the member need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

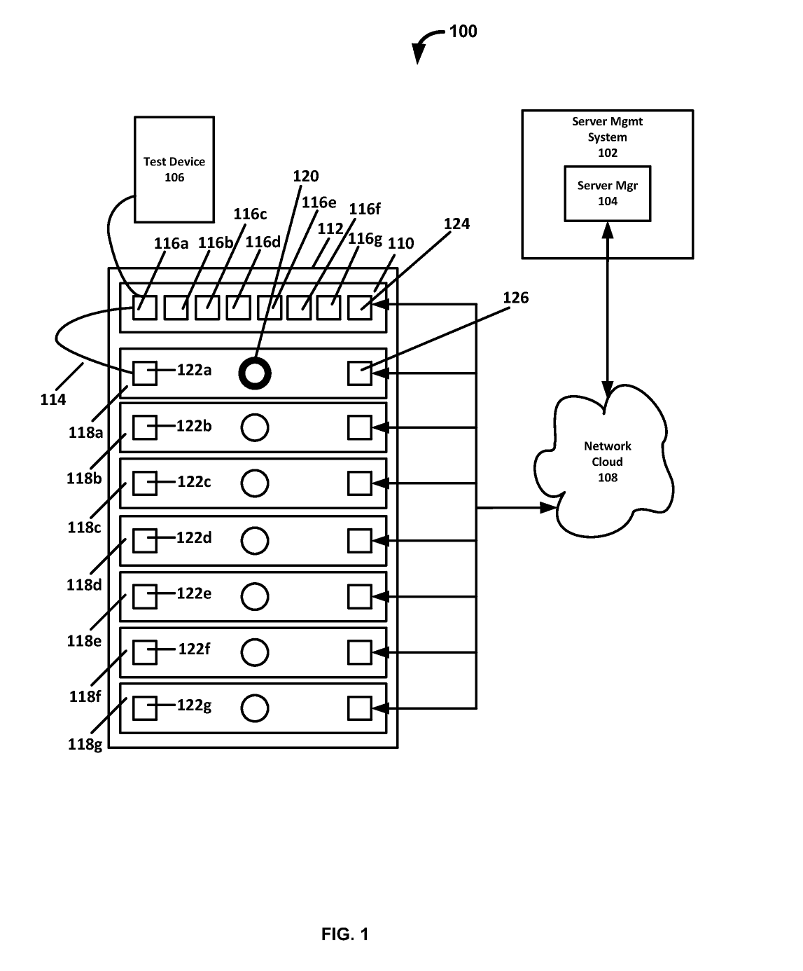

FIG. 1 illustrates a diagram of example system 100 for setting up and verifying cabling connections in a network. In some implementations, a computing device can be used to set up cabling connections in the network. For example, server manager 104 can be a program application executed from server management system 102 used to set up cabling connections in the network. Server management system 102 can comprise a computing device such as a laptop computer, personal computer, tablet computer, etc. In some implementations, server manager 104 can comprise a software application that is operated by a system administrator (e.g., a user).

In some implementations, server manager 104 can send a first message to test device 106 through switch 110 of rack 112. Switch 110 can be any computer networking device known in the art, including, but not limited to, switching hub, bridging hub, MAC bridge, etc., and can include routing and bridging functions. Test device 106 can be a null device with the sole purpose of sending a confirmation response to the computing device that the first message is received. In some implementations, server manager 104 can provide a user interface (e.g., a graphical user interface (GUI)) that the system administrator can interact with to send the first message to test device 106. For example, the first message can be a signal sent with the purpose of eliciting a response from test device 106, such as a ping signal or a test signal. The first message can also comprise information regarding a media access control (MAC) address of server management system 102. Upon receiving the first message, test device 106 can respond to server manager 104 with a response signal. For example, the response signal can comprise information regarding switch port 116a being coupled to test device 106 (as shown in FIG. 1). The response signal can be sent to server management system 102 at its MAC address, where the response signal is received and processed by server manager 104. For example, server manager 104 can receive the response signal and can identify that switch port 116a is coupled to test device 106.

In some implementations, switch 110 can comprise a plurality of switch ports 116a-116g. For example, each switch port 116a-116g can be configured to be electronically coupled to a server at a server node. In some implementations, switch 110 can also comprise manager port 124 for coupling to server management system 102 through network cloud 108 (e.g., data center network, Internet, etc.) to allow server management system 102 to communicate with switch 110. For example, manger port 124 can comprise a RJ45 connector port for coupling with an Ethernet cable. In some implementations, rack 112 can house a plurality of servers 118a-118g. For example, each server 118a-118g can comprise server ports 122a-122g for coupling to switch ports 116a-116g. Each server port 122a-122g can comprise a server node. Servers 118a-118g can be any server known in the art, including, but not limited to, application servers, web servers, mail servers, mobile servers, file servers, host servers, rack mounted servers, etc.

In some implementations, server manager 104 can obtain configuration data specifying a mapping of switch ports 116a-116g to servers 118a-118g in rack 112. For example, the configuration data can be provided to server manager 104 by means commonly known in the art (e.g., downloaded from the Internet, hard drive, flash drive, optical disk, etc.) or can be pre-programmed into server manager 104. In some implementations, the configuration data can comprise information regarding servers 118a-118g and switch ports 116a-116g such as MAC addresses of servers 118a-118g and switch port numbers for switch ports 116a-116g. For example, the configuration data can specify a desired cabling setup for a shop-floor network server system. In some implementations, server manager 104 can use the configuration data to identify that server 118a corresponds to switch port 116a. For example, server manager 104 can use the port number of identified switch port 116a received in response to the signal sent to test device 106 to determine that particular server 118a is mapped to the port number of switch port 116a using the configuration data. In some implementations, the configuration data can be displayed on a GUI at server manager 104. For example, the configuration data can be displayed in a table format showing that switch port 116a should be coupled to server 118a, and whether there are errors in the connections.

In some implementations, server manager 104 can send a second message to server 118a to cause light 120 of server 118a to be turned on. For example, the second message can be a data signal comprising a MAC address of server 118a. In some implementations, server manager 104 can send the second message to system controller 126 located at server 118a. System controller 126 can be a baseboard management controller (BMC). For example, system controller 126 can receive the second message and cause light 120 to turn on. In some implementations, each server 118a-118g can comprise a system controller 126 and a light 120. Light 120 can be any type of light known in the art, including, but not limited to, LED, fluorescent, CFL, halogen, incandescent, etc. In some implementations, light 120 can indicate the particular server that is to be connected to the identified switch port currently connected to test device 106. For example, light 120 located at server 118a can indicate to a system administrator that server port 122a is to be coupled to switch port 116a. In some implementations, light 120 can be adapted to blink or flash to notify the system administrator of the particular server to connect to the identified switch port. Coupling of switch port 116a to server port 122a can be through network cabling 114. For example, network cabling 114 can be an Ethernet cable or any other type of cable used for networking purposes. In some implementations the above steps can be repeated to set up all the cabling connections in the network to connect switch ports 116a-116g to servers 118a-118g at server ports 122a-122g.

In some implementations, system controllers 126 located at servers 118a-118g can be coupled to server manager 104 through network cloud 108. System controllers 126 can be adapted to send server identification information regarding servers 118a-118g to server manager 104. For example, the server identification information can be MAC addresses of servers 118a-118g. The server MAC addresses can be located at a plurality of network interface controllers (NICs) located at each server 118a-118g. In some implementations, the server identification information can be received at server manager 104 prior to sending the first message. For example, server manager 104 can receive the MAC addresses of servers 118a-118g, and can map the server MAC addresses to switch ports 116a-116g according to the configuration data mapping information.

In some implementations, a computing device can be used to verify cabling connections in a network. For example, after setting up network cabling in accordance with the above disclosure to couple switch ports 116a-116g to server ports 122a-122g, server manager 104 can verify that the cabling connections were correctly done.

In some implementations, the computing device can obtain configuration data comprising a desired mapping of switch ports 116a-116g to servers 118a-118g in rack 112. For example, server management system 102 can comprise server manager 104 for obtaining the configuration data. In some implementations, the configuration data can be provided to server manager 104 by means commonly known in the art (e.g., downloaded from the Internet, hard drive, flash drive, optical disk, etc.) or can be pre-programmed into server manager 104. In some implementations, the configuration data can comprise information regarding servers 118a-118g and switch ports 116a-116g such as MAC addresses of servers 118a-118g and switch port numbers for switch ports 116a-116g. For example, the configuration data can be a predefined cabling setup for a shop-floor network server system. In some implementations, the mapping of switch ports 116a-116g to servers 118a-118g can be presented in a table format generated in a GUI on server manager 104. For example, the table can show which server should be coupled to which switch port.

In some implementations, the computing device can receive a current mapping identifying current couplings of each switch port 116a-116g to servers 118a-118g. For example, switch 110 can be configured to automatically generate a current mapping (e.g., forwarding table) identifying current couplings of each switch port 116a-116g to servers 118a-118g. Switch 110 can automatically send the current mapping to server manager 104. In some implementations, server manager 104 receives the current mapping automatically from switch 100 once all switch ports 116a-116g have been coupled to servers 118a-118g. For example, the current mapping can be received by server manager 104 as a data file comprising information regarding the current cabling configuration of rack 112. In some implementations, the current mapping can be displayed on a GUI on server manager 104. For example, server manager 104 can display the current mapping in a table format, showing the current couplings of each switch port 116a-116g to servers 118a-118g at server ports 122a-122g.

In some implementations, the computing device can compare the current mapping to the desired mapping, and provide an error indication to a user when the current mapping does not match the desired mapping. For example, server manager 104 can generate a comparison table showing whether there are any differences between the current mapping and the desired mapping. In some implementations, the comparison table can show the current mapping, the desired mapping, whether the current mapping matches the desired mapping, whether there are errors, and where the errors are located. The comparison table can be displayed on a GUI on server manager 104. For example, the comparison table can include information regarding the switch port numbers and server MAC addresses. In some implementations, the comparison table can include an indication of whether there are errors in the couplings. For example, the column can be arranged such that each row corresponds to information regarding a specific coupling. The comparison table can include a column showing whether specific couplings are erroneous. In some implementations the error indication can be sent to a user device (e.g., a desktop computer, laptop, tablet computer, smartphone, etc.) through an E-mail message or short message service (SMS) text message. In other implementations, the error indication can be through lights 120 on servers 118a-118g.

In some implementations, the error indication can comprise information regarding how to correct the error. For example, the error indication can indicate that switch port 116a is erroneously coupled to server port 122b and instead should be coupled to 122a. In some implementations, information regarding the error and how to correct it can be displayed in the comparison table in the GUI. In some implementations, the error indication can comprise information regarding a signal strength of the cabling. For example, if a cable is not securely coupled to the server or the switch, server manager 104 can detect that the signal strength is weak, and can send an error indication showing that the cable is not securely coupled. The cable can then be securely coupled to allow for maximum signal strength.

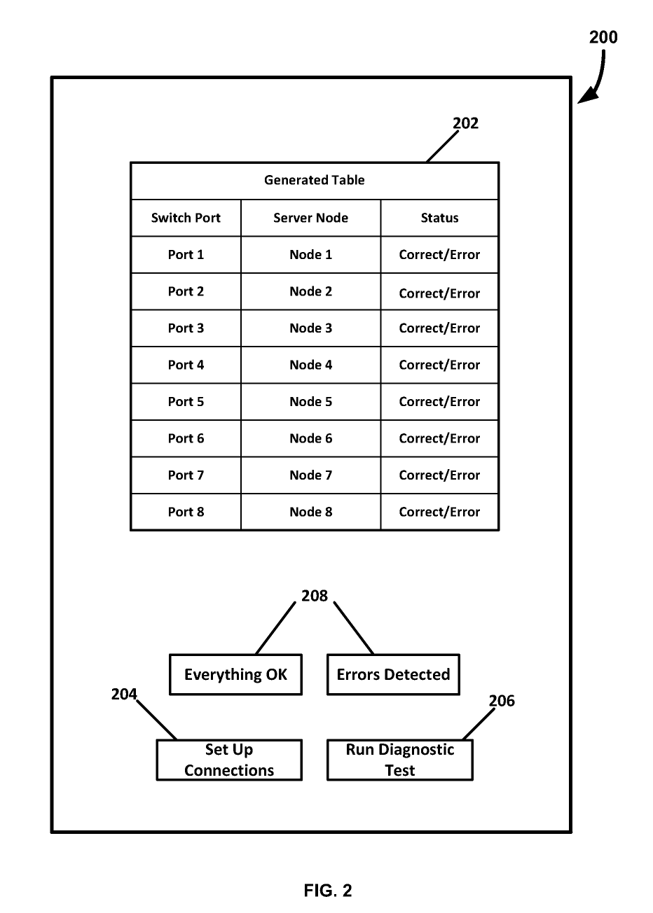

FIG. 2 illustrates an example graphical user interface (GUI) 200 generated by a computing device. For example, GUI 200 can be presented on a display device of server management system 102. In some implementations, GUI 200 can comprise cabling information 202 indicating a mapping of switch ports to server nodes. For example, cabling information 202 can comprise a desired mapping of switch ports to server nodes. Cabling information 202 can comprise a current mapping of switch ports to server nodes, for example. In some implementations, cabling information 202 can comprise a comparison of the desired mapping to the current mapping, and can indicate whether there is an error. For example, cabling information 202 can comprise a status indicator of whether the cabling is “Correct” or has an “Error”. In some implementations cabling information 202 can be presented in a table format. For example, cabling information 202 can comprise columns for “Switch Port”, “Server Node”, and “Status”, with each row corresponding to a particular port number, server port, and status.

In some implementations, a user can use GUI 200 to set up cabling connections in the network. For example, the user can select a set up command 204 to cause the computing device to set up the cabling connections according to a desired mapping. Set up command 204 can be an interactive button displayed on GUI where, when selected by a user (e.g., using a mouse), initiates set up of network cabling according to the above disclosure. In some implementations, the desired mapping can be displayed as cabling information 202. The cabling set up can be completed according to the disclosure herein, using lights to indicate which server to couple to which switch port.

In some implementations, at the conclusion of setting up the cabling connections, the user can select diagnostic test command 206. For example, selecting diagnostic test command 206 causes the computing device to verify whether the cabling connections were correctly done. Diagnostic test command 206 can be an interactive button displayed on GUI where, when selected by a user (e.g., using a mouse), initiates a diagnostic test of network cabling connections according to the above disclosure. In some implementations, the computing device compares a current mapping to the desired (e.g., configured) mapping, as disclosed above. At the conclusion of the diagnostic test, an indicator 208 is displayed, either showing “Everything OK” or “Errors Detected”. If there are errors, the errors can be displayed in cabling information 202 to allow the user to correct them. Once the corrections are made, the user can select diagnostic test command 206 again. The above can be repeated until all cabling connections are correctly coupled.

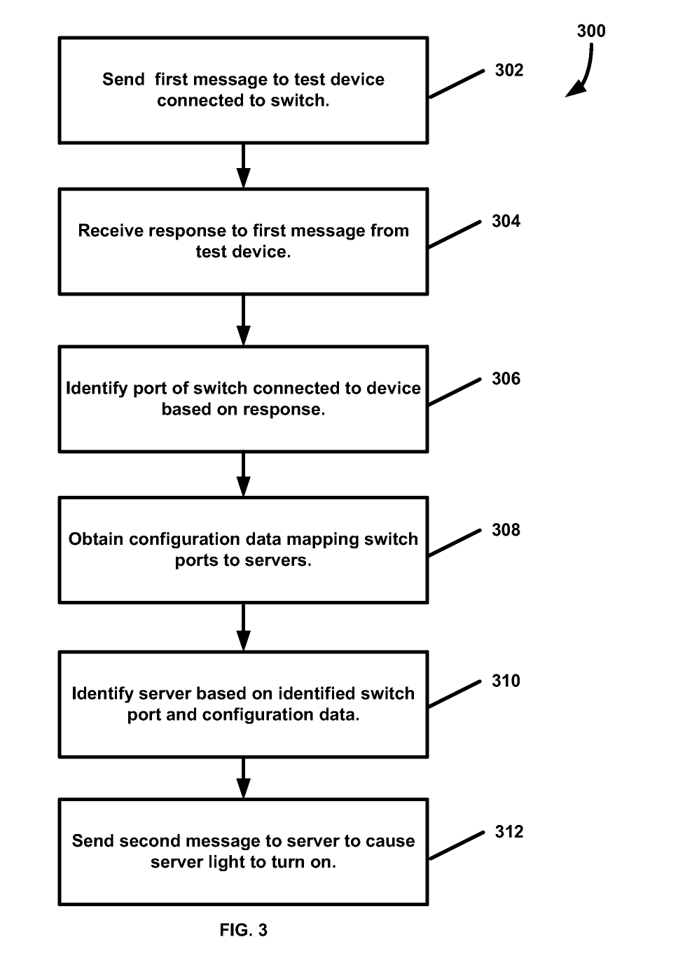

Referring to FIGS. 1 and 3, FIG. 3 is a flow diagram of an example process 300 for setting up cabling connections in a network. The method described below can be carried out using the configurations illustrated in FIGS. 1 and 2, for example, and various elements of these figures are referenced in explaining the example method. Each block shown in FIG. 3 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method begins at block 302.

At block 302, a first message is sent from a computing device to a test device through a switch of a server rack. For example, the first message can be a test signal. The first message can comprise information regarding the computing device, such as MAC address.

At block 304, a response to the first message is received from the test device at the computing device. For example, the test device can be a null device with the sole purpose of sending a response to the computing device once the first message is received. The response can be a response signal comprising information regarding which switch port the test device is coupled to.

At block 306, the computing device identifies a port of the switch currently connected to the test device based on the response. For example, the computing device can identify the switch port connected to the test device because the response signal comprises information regarding which switch port the test device is coupled to.

At block 308, the computing device obtains configuration data mapping ports of the switch to servers in the server rack. For example, the configuration data can be provided to the computing device by means commonly known in the art (e.g., downloaded from the Internet, hard drive, flash drive, optical disk, etc.) or can be pre-programmed into the computing device. In some implementations the configuration data can be displayed in a GUI on the computing device.

At block 310, the computing device identifies a particular server corresponding to the identified switch port based on the configuration data. For example, the computing device can use the configuration data to determine the particular server that corresponds to the identified switch port.

At block 312, the computing device sends a second message to the particular server to cause a light of the particular server to be turned on. For example, the light can be a LED light that flashes or stays on without flashing. In some implementations the light indicates to a user which particular server to couple to the identified switch port.

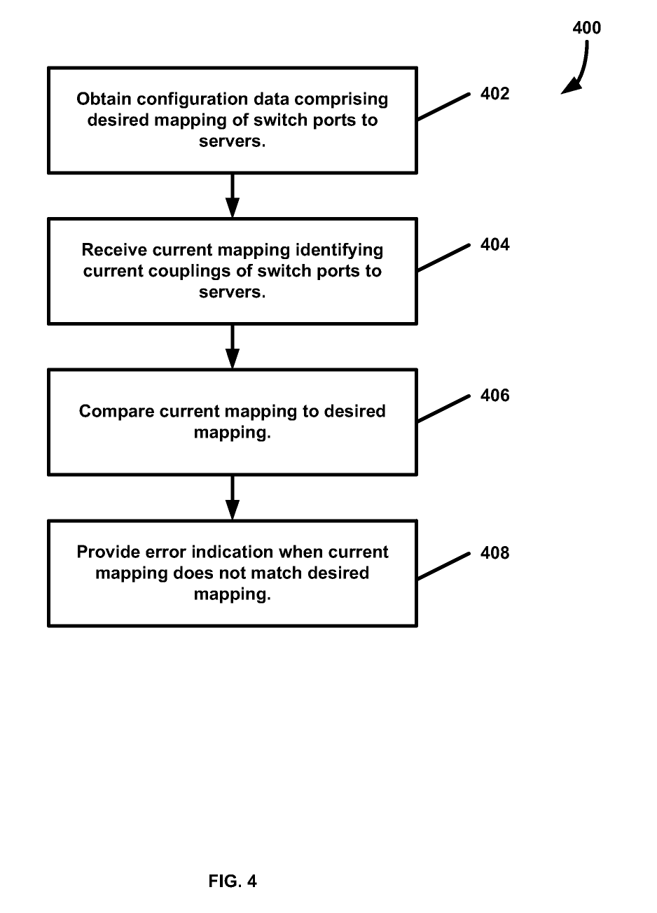

Referring to FIGS. 1 and 4, FIG. 4 is a flow diagram of an example process 400 for verifying cabling connections in a network. The method described below can be carried out using the configurations illustrated in FIGS. 1 and 2, for example, and various elements of these figures are referenced in explaining the example method. Each block shown in FIG. 4 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method begins at block 402.

At block 402, a computing device obtains configuration data comprising a desired mapping of each of a plurality of switch ports to a corresponding one of a plurality of servers in a rack. For example, the configuration data can be provided to the computing device by means commonly known in the art (e.g., downloaded from the Internet, hard drive, flash drive, optical disk, etc.) or can be pre-programmed into the computing device. The configuration data can be generated and provided by a system administrator, for example. In some implementations the configuration data can be displayed in a GUI on the computing device.

At block 404, the computing device receives a current mapping identifying current couplings of each of the plurality of switch ports to a corresponding one of the plurality of servers. For example, the switch can be configured to automatically generate the current mapping identifying current couplings of each switch port to the servers. In some implementations, switch can automatically send the current mapping to a server manager. In some implementations, the server manager can request the current mapping from the switch.

At block 406, the computing device compares the current mapping to the desired mapping. For example, the computing device can generate a comparison table on the GUI showing a side-by-side comparison of data in the current mapping to data in the desired mapping.

At block 408, an error indication is provided to a user when the current mapping does not match the desired mapping. For example, the error indication can be communicated to the user through lights (e.g., LED, fluorescent, CFL, halogen, incandescent, etc.) on the servers, E-mail, or SMS text messages. In some implementations the error indication can also comprise information regarding how to fix the error. For example, the error indication can be displayed on the GUI in a table format, showing which switch ports are erroneously coupled to the servers, and how the switch ports should be coupled to the servers to correct the errors.

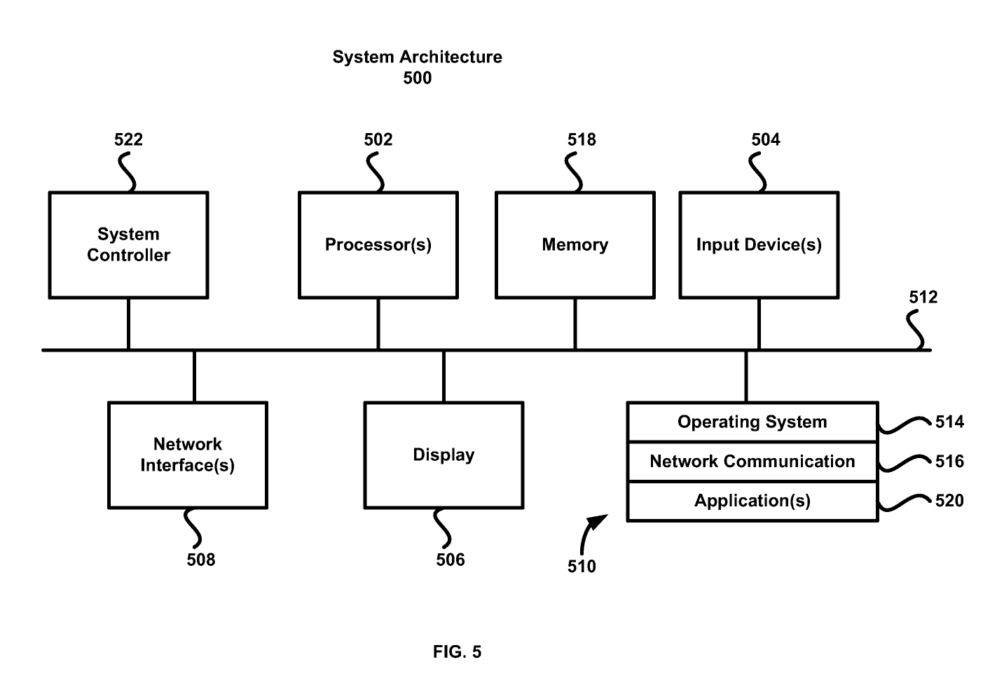

FIG. 5 is a block diagram of an example system architecture 500 implementing the features and processes of FIGS. 1-4. The architecture 500 can be implemented on any electronic device that runs software applications derived from compiled instructions, including without limitation personal computers, servers, smart phones, media players, electronic tablets, game consoles, email devices, etc. In some implementations, the architecture 500 can include one or more processors 502, one or more input devices 504, one or more display devices 506, one or more network interfaces 508 and one or more computer-readable mediums 510. Each of these components can be coupled by bus 512.

In some implementations, system architecture 500 can correspond to a single server (e.g., server 118a) in a rack of servers, the server management system 102 or the test device 106. Various rack configurations can be implemented. For example, a rack can include multiple chassis and each chassis can contain multiple servers. Each server in the rack can be connected by various hardware components (e.g., backbone, middle plane, etc.). Each server in the rack can be connected to a network through a top-of-rack switch.

Display device 506 can be any known display technology, including but not limited to display devices using Liquid Crystal Display (LCD) or Light Emitting Diode (LED) technology. Processor(s) 502 can use any known processor technology, including but are not limited to graphics processors and multi-core processors. Input device 504 can be any known input device technology, including but not limited to a keyboard (including a virtual keyboard), mouse, track ball, and touch-sensitive pad or display. Bus 512 can be any known internal or external bus technology, including but not limited to ISA, EISA, PCI, PCI Express, NuBus, USB, Serial ATA or FireWire.

Computer-readable medium 510 can be any medium that participates in providing instructions to processor(s) 502 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Computer-readable medium 510 can include various instructions for implementing operating system 514 (e.g., Mac OS®, Windows®, Linux, etc.) and applications 520 such as computer programs. The operating system can be multi-user, multiprocessing, multitasking, multithreading, real-time and the like. The operating system 514 performs basic tasks, including but not limited to: recognizing input from input device 504; sending output to display device 506; keeping track of files and directories on computer-readable medium 510; controlling peripheral devices (e.g., disk drives, printers, etc.) which can be controlled directly or through an I/O controller; and managing traffic on bus 512. Operating system 514 can include an agent (e.g., software application, utility, program, etc.) configured to request an IP address from system controller 522 and invoke operating system functions for configuring the server IP address based on the IP address received from the system controller 522, as described above with reference to FIGS. 1-4. Network communications instructions 516 can establish and maintain network connections (e.g., software for implementing communication protocols, such as TCP/IP, HTTP, Ethernet, etc.).

Memory 518 can include high-speed random access memory and/or non-volatile memory, such as one or more magnetic disk storage devices, one or more optical storage devices, and/or flash memory (e.g., NAND, NOR). The memory 518 (e.g., computer-readable storage devices, mediums, and memories) can include a cable or wireless signal containing a bit stream and the like. However, when mentioned, non-transitory computer-readable storage media expressly exclude media such as energy, carrier signals, electromagnetic waves, and signals per se. The memory 518 can store an operating system, such as Darwin, RTXC, LINUX, UNIX, OS X, WINDOWS, or an embedded operating system such as VxWorks.

System controller 522 can be a service processor that operates independently of processor 502. In some implementations, system controller 522 can be a baseboard management controller (BMC). For example, a BMC is a specialized service processor that monitors the physical state of a computer, network server, or other hardware device using sensors and communicating with the system administrator through an independent connection. The BMC is configured on the motherboard or main circuit board of the device to be monitored. The sensors of a BMC can measure internal physical variables such as temperature, humidity, power-supply voltage, fan speeds, communications parameters and operating system (OS) functions.

In some implementations, the BMC runs independently of processor 502 and hence in the event of processor 502, memory 518 or any other hardware failure, the BMC can still provide services and remain functional. In some implementations, the BMC can start running as soon as a server is plugged into a power source (e.g., power supply unit, backup power unit, power distribution unit, etc.). For example, the power button on the front side of the blade does not turn on/off the BMC. The management connectivity to the BMC is through two BMC-dedicated 100BASE-T interfaces on the blade to the chassis' internal management. However at any given instance the connectivity to the BMC is only through one of the two 100BASE-T interfaces, the other one being redundant. A system administrator (e.g., using server manager 104) can interact (e.g., configure, monitor, etc.) with system controller 522 using the controller's intelligent platform management interface (IPMI). For example, the IPMI interface can be used to configure system controller 522 with the IP address for the server. Alternatively, system controller 522 can be configured (e.g., with software, firmware, etc.) with a non-IMPI interface (e.g., custom interface) that allows a system administrator to remotely configure the server's IP address using system controller 522.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an application programming interface (API). An API can define one or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
sending, from a computing device, a first message to a test device through a switch of a server rack;
receiving, at the computing device, a response to the first message from the test device;
identifying, by the computing device, a port of the switch currently connected to the test device based on the response;
obtaining, by the computing device, configuration data mapping ports of the switch to servers in the server rack;
identifying, by the computing device, a particular server corresponding to the identified switch port based on the configuration data; and
sending, by the computing device, a second message to the particular server to cause a light of the particular server to be turned on.

2. The method of claim 1 further comprising, prior to sending the first message to the test device, obtaining at the computing device a server identification for each of the servers.

3. The method of claim 2 wherein the server identification is a MAC address.

4. The method of claim 1 wherein the server identification is stored to the configuration data.

5. The method of claim 1 wherein the light is turned on by a service controller located at the particular server.

6. A method comprising:
obtaining, by a computing device, configuration data comprising a desired mapping of each of a plurality of switch ports to a corresponding one of a plurality of servers in a rack;
receiving, by the computing device from a switch in the rack, a current mapping identifying current couplings of each of the plurality of switch ports to a corresponding one of the plurality of servers;
comparing, by the computing device, the current mapping to the desired mapping; and
providing an error indication to a user when the current mapping does not match the desired mapping.

7. The method of claim 6 further comprising generating a table based on the comparing of the current mapping to the desired mapping.

8. The method of claim 7 wherein the table comprises information regarding differences between the current mapping and the desired mapping.

9. The method of claim 6 wherein the error indication comprises an E-mail, a short message service (SMS) text message, or a message displayed on a graphical user interface (GUI) on the computing device.

10. The method of claim 6 wherein the error indication comprises information regarding how to fix the current couplings.

11. A system comprising:
one or more processors; and
a computer-readable storage medium including one or more sequences of instructions which, when executed by the one or more processors, cause:
sending, from a computing device, a first message to a test device through a switch of a server rack;
receiving, at the computing device, a response to the first message from the test device;
identifying, by the computing device, a port of the switch currently connected to the test device based on the response;
obtaining, by the computing device, configuration data mapping ports of the switch to servers in the server rack;
identifying, by the computing device, a particular server corresponding to the identified switch port based on the configuration data; and
sending, by the computing device, a second message to the particular server to cause a light of the particular server to be turned on.

12. The system of claim 11 wherein the one or more sequences of instructions further cause, prior to sending the first message to the test device, obtaining at the computing device a server identification for each of the servers.

13. The system of claim 12 wherein the server identification is a MAC address.

14. The system of claim 11 wherein the server identification is stored to the configuration data.

15. The system of claim 11 wherein the light is turned on by a service controller located at the particular server.

16. A system comprising:
one or more processors; and
a computer-readable storage medium including one or more sequences of instructions which, when executed by the one or more processors, cause:
obtaining, by a computing device, configuration data comprising a desired mapping of each of a plurality of switch ports to a corresponding one of a plurality of servers in a rack;
receiving, by the computing device from a switch in the rack, a current mapping identifying current couplings of each of the plurality of switch ports to a corresponding one of the plurality of servers;
comparing, by the computing device, the current mapping to the desired mapping; and
providing an error indication to a user when the current mapping does not match the desired mapping.

17. The system of claim 16 wherein the one or more sequences of instructions further cause generating a table based on the comparing of the current mapping to the desired mapping.

18. The system of claim 17 wherein the table comprises information regarding differences between the current mapping and the desired mapping.

19. The system of claim 16 wherein the error indication comprises an E-mail, a short message service (SMS) text message, or a message displayed on a graphical user interface (GUI) on the computing device.

20. The system of claim 16 wherein the error indication comprises information regarding how to fix the current couplings.
